(19) United States
(12) Patent Application Publication
(10) Pub. No.: US 2009/0006154 A1
(43) Pub. Date: Jan. 1, 2009

(54) Declarative workflow designer

(75) Inventors: Eilene Hao, Bellevue, WA (US); Alex Malek, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/824,146

(22) Filed: Jun. 29, 2007

(51) Int. Cl. G06F 17/50

(52) U.S. Cl. 705/7

(57) ABSTRACT

A workflow designer enables a user to author a workflow by arranging building blocks in a particular order using a combination of a graphical designer and a rules based editor. The building blocks are encapsulated and displayed graphically to the user. The building blocks may correspond to events, conditions or actions that may include complex logic, sub steps, looping and parallel branching. Each building block is associated with source code that defines an action to be taken when the building block is processed. The workflow designer may be used to implement logic to provide flexibility and customization for the workflow schedule. Validation may also be performed to determine that all the required parameters have been properly set for the building blocks as well as to determine whether the building blocks are properly arranged.

### RELATED APPLICATIONS

This patent application is related to United States Patent Application Pub. No. 2006/0070025 filed on Sep. 30, 2004 and entitled “WORKFLOW SCHEDULE AUTHORING TOOL.”

### BACKGROUND

A workflow defines a series of tasks within an organization to produce a final outcome. Workflows allow for business process formalization and management. A workgroup computing application allows different workflows to be defined for different types of jobs. For example, in a publishing setting, a document may be automatically routed from writer to editor to proofreader to production. At each stage in the workflow, an individual or group is responsible for a specific task. Once the task is complete, the workflow software helps to ensure that the individuals responsible for the next task are notified and receive the data needed to execute the next stage of the process. Creating these workflows can be more difficult since many of the workflow designers are not familiar with source code.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A workflow designer that is a combination of a graphical designer and a rules based editor is used to author a workflow by arranging building blocks in a particular order. The building blocks are encapsulated and displayed graphically to the user. The building blocks may correspond to events, conditions or actions that may include complex logic, sub steps, looping and parallel branching. When arranging the building blocks, a user may utilize keyboard commands as well as a graphical user interface. Each building block is associated with source code that defines an action to be taken when the building block is processed. The workflow designer may be used to implement logic to provide flexibility and customization for the workflow schedule. Validation may also be performed to determine that all the required parameters have been properly set for the building blocks as well as to determine whether the building blocks are properly arranged.

### BRIEF DESCRIPTION OF THE DRAWINGS

FIG. 1 illustrates an exemplary computing device;

FIG. 2 shows a block diagram of a workflow design system;

FIG. 3 illustrates a workflow designer user interface;

FIG. 4 shows a system for authoring a workflow;

FIG. 5 illustrates using keyboard commands with a control object; and

FIG. 6 shows an illustrative process for authoring a workflow.

### DETAILED DESCRIPTION

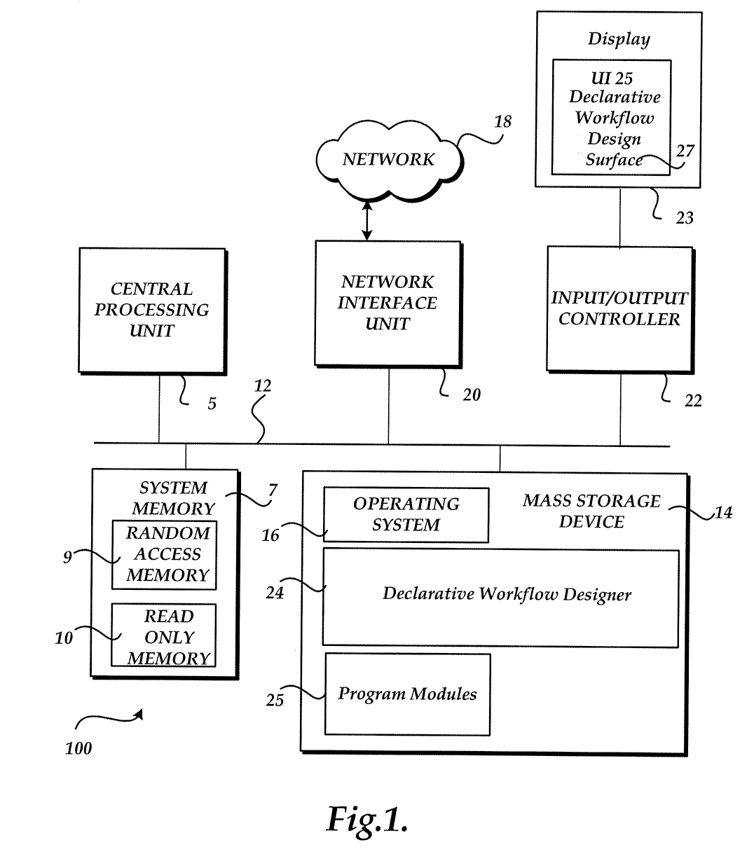

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, a declarative workflow design surface 27, a declarative workflow designer 24, and other program modules 25, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 23, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS® VISTA® operating system from MICROSOFT® CORPORATION of Redmond, Wash. The mass storage device 14 and RAM 9 may also store one or more program modules. In particular, the mass storage device 14 and the RAM 9 may store one or more application programs, such as a declarative workflow designer 24. The declarative workflow designer application 24 displays a design surface 27 through User Interface (“UI”) 25 on display 23.

Generally, the workflow designer application 24 enables a user to author a workflow by arranging building blocks in a particular order using a combination of a graphical designer and a rules based editor. The building blocks are encapsulated and displayed graphically to the user. The building blocks may correspond to events, conditions or actions that may include complex logic, sub steps, looping and parallel branching. Each building block is associated with source code that defines an action to be taken when the building block is processed. The workflow designer may be used to implement logic to provide flexibility and customization for the workflow schedule. Validation may also be performed to determine that all the required parameters have been properly set for the building blocks as well as to determine whether the building blocks are properly arranged. Additional details regarding the workflow designer will be provided below.

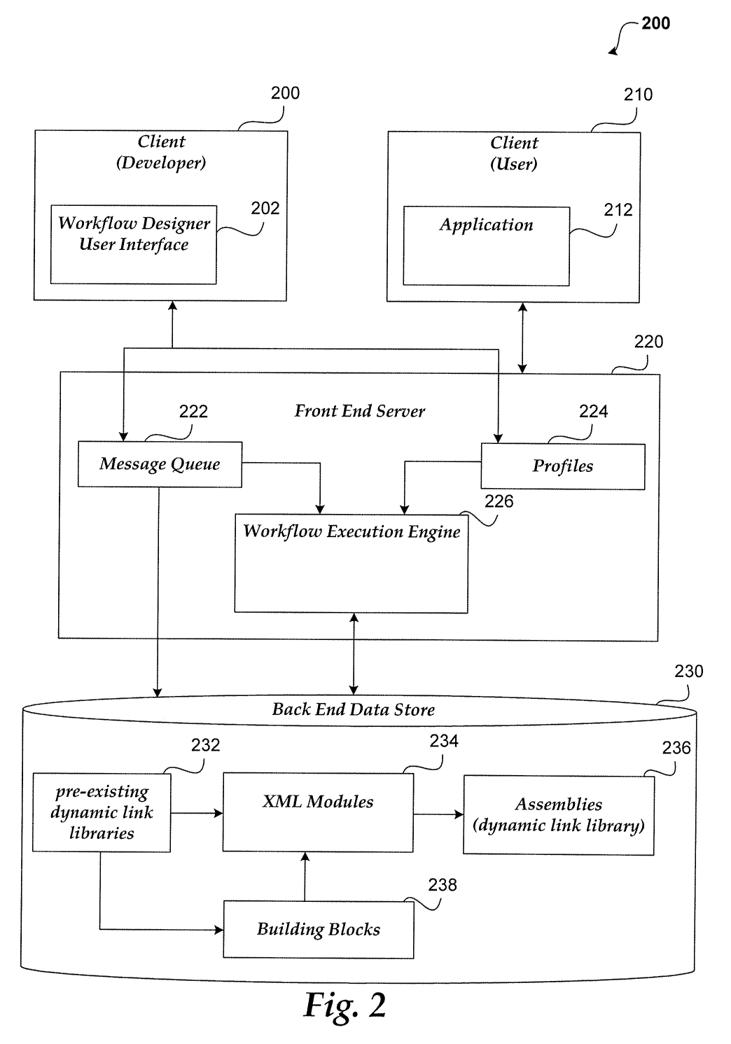

FIG. 2 illustrates a block diagram of a workflow design system. The system includes a client 200 for developer access, a client 210 for user access, a front end server 220, and a back end data store 230. Client 200, client 210 and back end data store 230 are each coupled to front end server 220. Client 200 includes workflow designer user interface 202. Client 210 includes application 212. Front end server 220 includes messaging queue 222, profiles 224, and workflow execution engine 226. Back end data store 230 includes pre-existing dynamic link libraries 232, XML modules 234, and assemblies 236. Building blocks 238 are coupled to XML modules 234.

The workflow schedule is authored by a developer at client 200 using workflow designer user interface 202. The workflow schedule may receive input from a user interacting with application 212 at client 210 while the workflow schedule is being processed. Processing of the workflow schedule may be halted or delayed until the required input is received from client 210. The workflow schedule continues processing when the input is received.

Messaging queue 222 is propagated across all front ends of server 220 in order to coordinate incoming and outgoing messages into the server system. Profiles 224 includes identification information related to clients 200, 210 such that a particular client may be located. Workflow execution engine 226 manages execution of the workflow schedule. For example, workflow execution engine may manage the workflow schedule by reordering a sequence of steps or by changing a sequence of steps to execute in parallel or serially.

Pre-existing dynamic link libraries 232 are functions that may be called by XML modules 234 such that all functions do not need to be constructed. Pre-existing dynamic link libraries 232 are abstracted by building blocks 238 (i.e., a pre-existing dynamic link library is referenced by using a building block). XML modules 234 are compiled to form assemblies 236. Assemblies 236 are execution-ready dynamic link libraries.

Building blocks 238 are sections of XML that comprise workflow actions. The action associated with the building block is executed when the building block is processed by workflow execution engine 222. The workflow schedule is authored by arranging building blocks 238 in a particular order. The order determines the workflow schedule process. Some building blocks may be predefined for commonly used actions. Other building blocks may be customized to execute a specific function or to provide a solution to a unique problem. Building blocks 238 simplify workflow schedule authoring because the user does not need to write any code. Building blocks 238 allow a developer to establish logic conditions for how the tasks in the workflow schedule are executed. For example, building blocks 238 may be arranged with logic connectors (e.g., AND, OR, ELSE, etc.) to provide branching and/or looping in the workflow schedule. Logic implementation provides flexibility and customization for the workflow schedule. For example, the logic may cause the workflow schedule to forward an expense report document to a specific person for approval when the expense is below a particular amount, and forward the expense report document to a different person when the expense report exceeds the amount.

Processing the workflow schedule begins when an event associated with the workflow assembly occurs. In one embodiment, the workflow schedule is associated with a button on a web page, and the event occurs when the button is activated. In another embodiment, the event occurs when client performs an operation that requires interaction with the workflow schedule. For example, the workflow schedule may be designed to generate an e-mail when a document in a document library is updated, such that the document is sent via e-mail to another user for approval. Thus, workflow schedule processing is triggered when the document is updated.

The workflow schedule executes an action depending on which logic condition is met. Each event, condition, and action may be represented as one separate building block. Thus, the workflow schedule shown above is authored by ordering five building blocks without writing any source code.

A building block may require a developer to input parameters before the building block may be executed. For example, a developer may select a “send e-mail” building block. A sentence may be generated at user interface 202 that reads “e-mail content to user”. “Content” and “user” are underlined signaling the developer that those fields require more information. The developer then enters the required information. The developer may click on content and then select a file to be e-mailed. Likewise, the developer may click on user and then select a recipient for the e-mail message. Thus, if the developer selects a document called “my proposal” and a recipient named “Joe” the sentence is changed to “e-mail my proposal to Joe”. The workflow schedule may then be saved and forwarded to the server to be compiled.

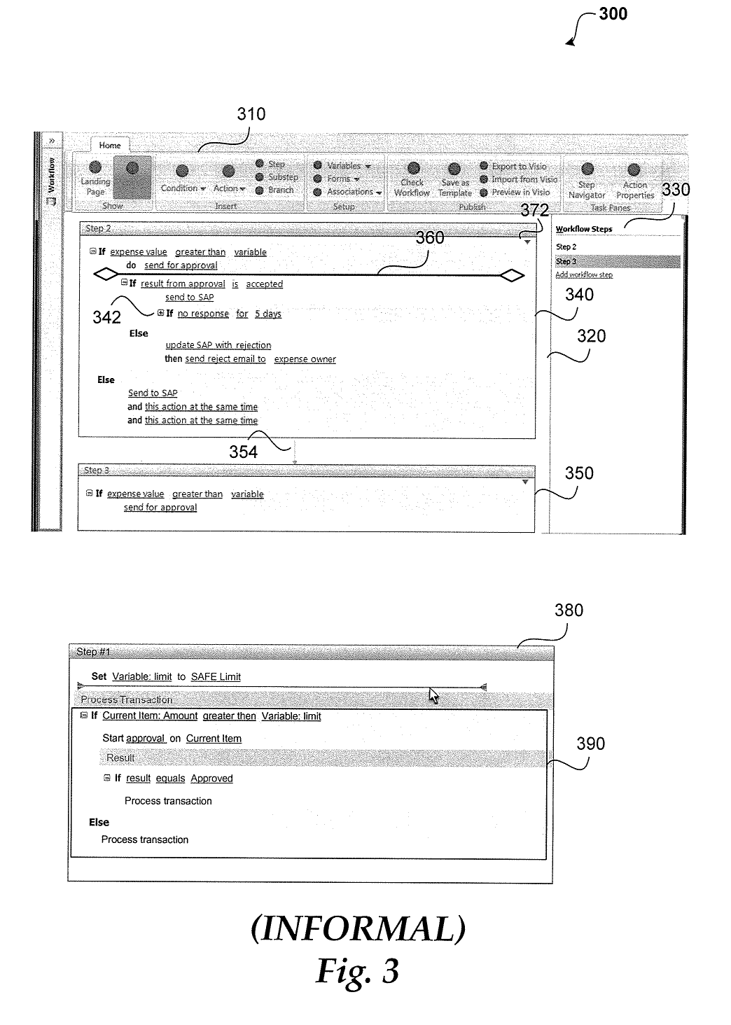

FIG. 3 illustrates a workflow designer user interface. Workflow designer user interface 300 includes a workflow design surface 320, a workflow ribbon 310, and step navigator 330.

The workflow ribbon 310 is a user interface that includes galleries for inserting actions, conditions, steps, and branches, clipboard options, view options, and quick access to related forms and visualizations. Users can insert objects onto the workflow design surface 320 from the ribbon as well. The ribbon 310 contains a gallery of objects that users can click to insert a particular object into the workflow at the currently active insertion point. Alternatively a graphical menu (such as a context menu) may be used. The ribbon 310, however, differs from a context menu in that it can be used even if there is no active insertion point. If an object or series of objects is selected rather than an insertion point, using the ribbon to insert will place the object directly after the selection, deselect the current selection and select the newly created object. If the object selected is a root step, a new root is created and the inserted object placed inside (conditions will add the condition block and branch as in the other insertion cases).

The step navigator 330 is a simple textual view of the steps in the workflow for easy navigation of the workflow. The step navigator 330 is used as a quick navigator to see what steps and sub steps are inside the workflow as well as to move around to different parts of the workflow that may be far away from each other in the design surface. The step navigator 330 can also be used to navigate through longer workflows that scroll off the screen, or workflows with several nested levels. According to one embodiment, the step navigator 330 displays the names of steps and sub steps inside a workflow. Each sub step is indented underneath a step to indicate its relationship. As new steps are added, moved, or deleted in the workflow design surface 320, the step navigator 330 is updated to reflect the current structure of the workflow. Clicking on one of the steps or sub steps in the step navigator 330 automatically selects the step in the workflow design surface 320. If the step is not in view within the workflow design surface, the workflow design surface scrolls so that the top of the selected step or sub step is at the top of the workflow design surface. In the current example, the step navigator 330 includes step 2 and step 3 as well as an option to add a workflow step.

The workflow design surface 320 is used for authoring the workflow. The workflow design surface 320 is a visualization of the workflow Extensible Object Markup Language (XOML's) logic. According to one embodiment, the workflow designer supports four building block object types including steps, rules, conditional blocks and conditional branches.

Steps are containers that group together conditional blocks, branches, and rules. The steps group logic and allow that logic to be moved and manipulated as a group within workflow design surface 320. Steps and sub steps are the same object but at a different level. According to one embodiment, each step is graphically depicted separately. For example, step 2 (340) is shown within a first graphical box while step 3 (350) is illustrated within another graphical box.

Conditional blocks link related conditional branches together. As can be seen in the current example, step 2 includes three conditional blocks. A first conditional block that is displayed shaded, a second conditional block that is shown within a white box and a third conditional block that is displayed shaded within the second conditional block. The third conditional block is shown collapsed such that all of the logic is not illustrated on the workflow design surface. According to one embodiment, the steps are presented as illustrated in step #1 screen 380. In this example, the sub steps are shaded, alternating between a first shading such as white and a second shading such as grey. The steps may also be displayed other ways. When a block is selected, the block may be displayed such that it is distinguished as being selected. For example, the block may be displayed with an outline (390). Steps may be viewed in a collapsed state and an expanded state. When collapsed, the step is displayed as a sentence with the title bar highlighted but contents hidden. To expand or collapse a step, users can click on the “+” or “−” icon to toggle the expansion or use the ribbon to expand the step they are currently working within. To aid visualization of large workflows with many steps, users can collapse or expand all sub steps using the Expand All and Collapse All buttons on the ribbon 310.

The workflow designer may move between the scopes of the workflow using keyboard commands and/or the mouse, or some other input device. A scope to is a container/composite activity that contains other activities or containers. Everything inside that container is said to be in that container's scope. For example, steps are scopes that can contain conditional blocks and actions. Conditional blocks are scopes that must contain at least one conditional branch and contain conditional branches. Conditional branches are scopes that can contain conditions followed by actions.

According to one embodiment, steps are displayed in order vertically down the canvas. Between each step, there is an arrow (such as arrow 354 between steps 2 and 3) pointing down to the next step.

To do enable users to insert objects in various places, an insertion cursor 360 is displayed on the design surface 320. According to one embodiment, an object may be inserted between every object. According to one embodiment, each scope has insertion points available at the top and bottom and before and after any objects. According to one embodiment, the insertion point cursor is approximately as wide as the scope. The insertion point cursor may be moved with keyboard commands or through a mouse selection. The cursor commands include an Up/Down keyboard command that moves to the next available insertion point up or down, that possibly crosses a scope boundary. The Ctrl+Up/Down keyboard command moves to the cursor at the top of the nearest scope object in pressed direction in current scope. If there is no other scope remaining, this command moves the insertion point cursor to the top or bottom of the workflow. The Home/End keyboard command moves the cursor to the top or bottom position of the current scope. The Ctrl+Home/End keyboard command moves the cursor to the topmost or bottommost cursor position of the workflow. The Page Up/Page Down keyboard command moves the cursor to the top or bottom of the current location. located at the top or bottom of the current visible design surface. Insertion cursors can also be activated with Tab or Right (Left for RTL), which cycles through the objects according to tab order specified. After moving past the object selections, the next insertion cursor available will be activated.

Alternatively, a user can use the mouse to click in the region between objects or between objects and scope borders to activate any cursor. When hovering over an insertion point region, the mouse displays an insertion cursor when hovering over text. According to one embodiment, the cursor is similar in appearance to the display of the actual cursor but shaded lighter. If the user clicks, the insertion cursor at that insertion point is activated. If a user changes focus from a cursor to something else inside the design surface, e.g. by clicking on an object or field binding to select it, the insertion cursor loses focus and disappears. If the insertion cursor is active and the user clicks anywhere outside of the design surface (e.g. step navigator or ribbon), the insertion cursor remains active.

A user may also utilize a menu to perform operations on the objects. According to one embodiment, an options menu is viewable when an object is selected. Generally, many different actions may be included within an options menu. The following is merely an example of contents of option menus that are associated with objects. A rule's option's menu includes the options to move a rule (up or down), delete the rule, or display the properties of the rule. The option to move up a rule, moves a rule up in the current scope (above the previous object in that scope). The option to move down a rule, moves the rule down in scope. According to one embodiment, the option menu becomes visible when the rule is selected. For example, a border may be displayed around the object with a drop arrow that is used to access the context menu. In FIG. 3, the drop arrow 372 for Step 2 (340) is illustrated.

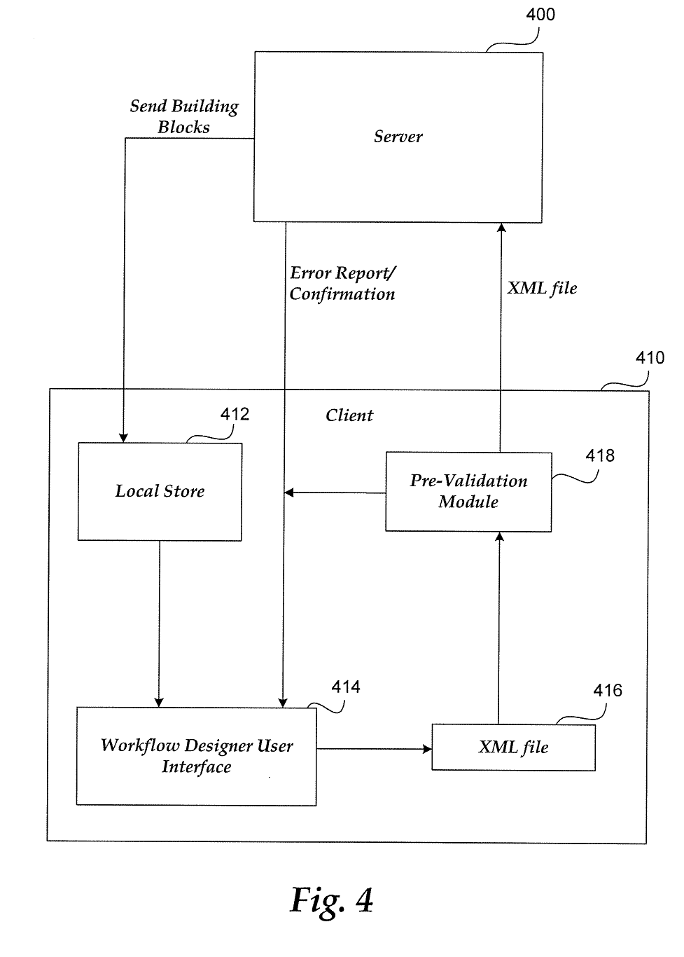

FIG. 4 illustrates a system for authoring a workflow. The system includes server 400 coupled to client 410. Server 400 may include multiple front end servers and back end data stores. Client 410 includes local store 412, workflow designer user interface 414, XML file 416, and pre-validation module 418.

Authoring the workflow involves arranging building blocks into a series of steps. Building blocks may be obtained from server 400. The developer authors the workflow using workflow designer user interface 414. According to one embodiment, workflow designer user interface 414 is a user interface such as the one described in reference to FIG. 3.

The developer generates the workflow using building blocks combined with logic. In one embodiment, existing workflow may be used in conjunction with the building blocks to create a new workflow. Any existing workflows that are available may be loaded onto client 410 such that the user may edit an existing workflow or incorporate the existing workflow in a new workflow. As discussed above, there are four building blocks in the workflow designer, including: steps, conditional blocks, conditional branches, and rules (conditions and actions). Rules are considered the base building blocks of a workflow. The rules include links that bind to data. The developer may save the workflow when desired. The saved workflow is then converted to XML file 416.

XML file 416 is loaded to pre-validation module 418 to check for errors in the syntax and semantics of the building blocks. Pre-validation module 418 may check XML file 416 to determine that all the required parameters have been properly set for the building blocks. Pre-validation module 418 may also determine whether the building blocks are properly arranged. The developer is informed of any syntactical or semantic errors at editor 414. The developer may then correct the workflow. Server 400 compiles XML file 416 to determine that the workflow schedule works properly. Server 400 informs client 410 of the compilation results by generating and sending an error report or confirmation.

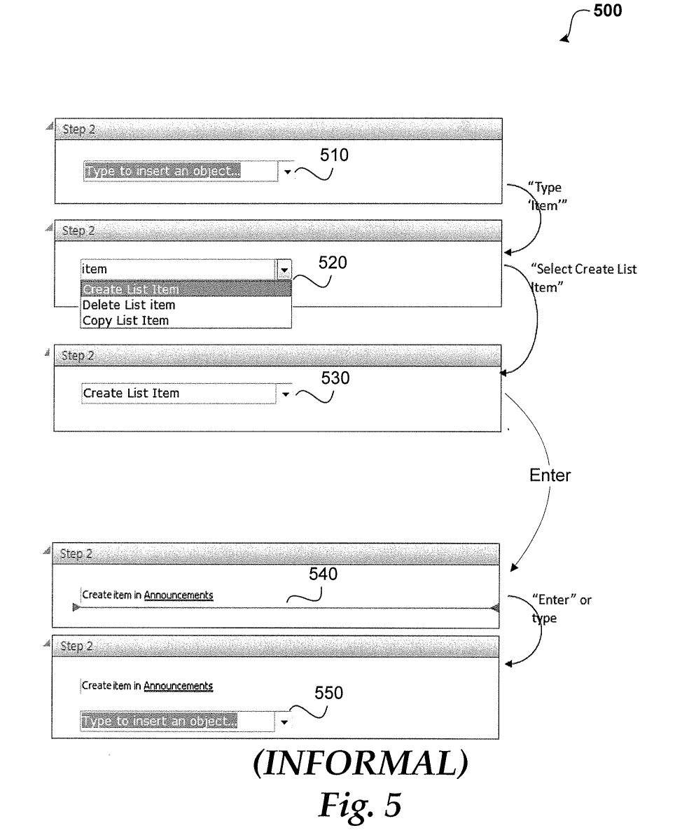

FIG. 5 illustrates using keyboard commands with a control object. As discussed above, keyboard commands assist a user in rule editing. According to one embodiment, a graphical control 510 is utilized to type names of objects and select the appropriate sentence or rule, and keyboard shortcuts for grouping and changing scope. The control acts as a placeholder for an object on the design surface that transforms into the object selected once it loses focus. Users can type text in this control, and the control filters the text to the titles of objects available in the current location that contain matching text. To insert a control, a user can select an insertion point and start typing or press “Enter.” In the current example, a user has typed “item” in control 520, moved the selection over “Create List Item” 520, selected “Create List Item” by pressing enter (530), which will create the item in Announcements (540). To create another control (e.g. control 550), the user may repeat the process above by pressing enter or beginning typing (540).

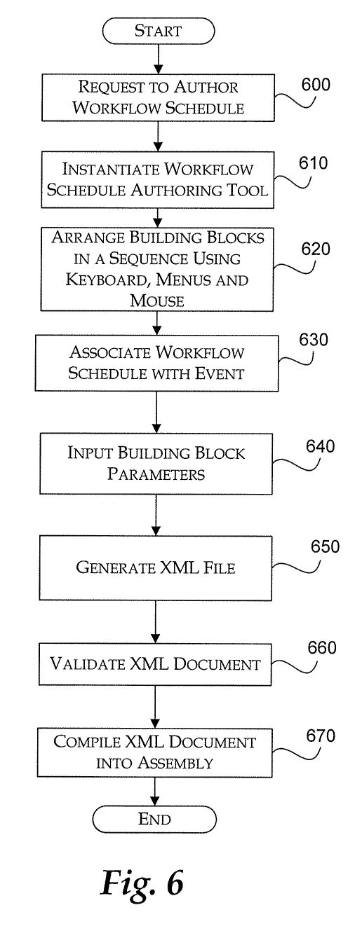

Referring now to FIG. 6, an illustrative process for authoring a workflow will be described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 600, where a request to author a workflow is made to a workflow user interface on a client.

Advancing to operation 610, the workflow designer is instantiated. The workflow designer enables a user to author a workflow by arranging building blocks in a particular order using a combination of a graphical designer and a rules based editor. The building blocks are encapsulated and displayed graphically to the user.

Continuing to operation 620, the building blocks are arranged in a particular sequence. The building block sequence determines the process for executing the workflow schedule. In one embodiment, the building blocks may be arranged to include logic conditions for executing the workflow schedule such that the building blocks are not executed sequentially. In another embodiment, existing workflow schedules may be edited or arranged with other workflow schedules and/or building blocks to create a new workflow schedule. The user may arrange the building blocks using keyboard commands, menus (i.e. ribbon menu, context menus) as well as using a mouse or some other input means.

Advancing to operation 630, the workflow is associated with an event. The workflow begins processing when the event occurs. For example, the event may be the activation of a button on a web page, a user interaction with the workflow, and the like.

Transitioning to operation 640, the user inputs parameters for the building blocks. The parameters allows the user to customize the building block. Examples of parameters include a filename, an e-mail address, and a uniform resource locator.

Proceeding to operation 650, an XML document is generated from the workflow created from the building blocks and the pre-existing workflow schedules. The XML document includes the source code associated with the workflow schedule.

Continuing to operation 660, the XML document is validated. Validation determines that the user has entered all the necessary parameters for the building blocks, and that the building blocks are properly sequenced. If the content or arrangement of the building blocks is invalid, the user is prompted to address the error.

Moving to operation 670, the XML document is compiled into an assembly. The assembly is an execution-ready dynamic link library. The validated and compiled assembly is available on a front end of the server. Processing then moves to an end block.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for authoring a workflow, comprising:
instantiating a workflow tool that is configured to design the workflow; wherein the workflow tool is used to arrange building blocks in a sequence; wherein the workflow tool includes a rules based editor and a design surface that displays the building blocks graphically; and wherein the building blocks include steps, sub steps, conditional blocks, conditional branches and rules; wherein the rules are sentences that include a link for data binding;
determining the sequence of the building blocks using a combination of keyboard commands and inputs from a graphical input device on the design surface;
displaying the steps on the design surface such that each step is selectable;
generating a mark-up language document according to the determined sequence of building blocks; and
storing the mark-up language document.

2. The method of claim 1, further comprising defining complex logic to manipulate the building blocks according to selected conditions when the mark-up language document is executed.

3. The method of claim 1, further comprising validating the mark-up language document.

4. The method of claim 1, wherein each of the steps is a container that groups the conditional blocks, the conditional branches and rules; and wherein each step groups logic that is manipulated as a group.

5. The method of claim 4, wherein each of the steps includes a name, a context menu, a type that is selected from a basic step and an iteration step, a step body including the logic for the step; and a mode that indicates execution of the step in serial or parallel.

6. The method of claim 1, wherein the conditional branch is a container that includes a section for conditions and a section for actions.

7. The method of claim 1, wherein each of the adjacent building blocks is displayed differently from the other building blocks.

8. The method of claim 1, further comprising receiving a keyboard command that instructs an insertion cursor to move to a different insertion point on the design surface.

9. The method of claim 1, further comprising receiving an input from the graphical input device to place the insertion cursor at a different insertion point.

10. The method of claim 1, wherein each rule includes an option menu that includes options to move the rule up in the current scope, down in the current scope, delete the rule and display properties relating to the rule.

11. A computer-readable medium having computer-executable instructions for arranging building blocks using a workflow design tool, comprising:
instantiating a workflow tool that is configured to arrange building blocks in a sequence to define a workflow; wherein the building blocks include steps, sub steps, conditional blocks, conditional branches and rules; wherein the rules are sentences that include a link for data binding;
displaying the rules as text within a selectable graphical element on a design surface;
determining the sequence of the building blocks using a combination of keyboard commands and inputs from a graphical input device;
displaying the building blocks on the design surface such that each building block is selectable;
generating a mark-up language document according to the determined sequence of building blocks; and
storing the mark-up language document.

12. The computer-readable medium of claim 11, wherein each of the steps is a container that groups the conditional blocks, the conditional branches and rules; and wherein each step groups logic that is manipulated as a group.

13. The computer-readable medium of claim 12, wherein each of the adjacent building blocks is colored differently such that it is distinguishable from the other building blocks.

14. The computer-readable medium of claim 12, further comprising receiving a keyboard command that instructs a control to be inserted at a current insertion point on the design surface.

15. The computer-readable medium of claim 12, further comprising moving the building blocks on the design surface in response to keyboard commands and inputs from the graphical input device.

16. The method of claim 15, wherein moving the building blocks is in response to a selected menu option.

17. A system for designing a workflow, comprising:
a processor and a computer-readable medium;
an operating environment stored on the computer-readable medium and executing on the processor; and
a workflow tool operating under the control of the operating environment and operative to:
receive input to arrange building blocks in a sequence to define the workflow; wherein the building blocks include steps, sub steps, conditional blocks, conditional branches and rules; wherein the rules are sentences that include a link for data binding; and wherein each of the steps is a container that groups the conditional blocks, the conditional branches and rules; and wherein each of the steps groups logic that is manipulated as a group;
display the building blocks on a design surface displayed on a display such that each building block is selectable;
determine the sequence of the building blocks using a combination of keyboard commands and inputs from a graphical input device;
generate a mark-up language document according to the determined sequence of building blocks; and
store the mark-up language document.

18. The system of claim 17, wherein the workflow tool is further configured to display each of the building blocks differently such that each of the adjacent building blocks is distinguishable from the other adjacent building blocks.

19. The system of claim 17, further comprising receiving a keyboard command that instructs an object to be inserted at a current insertion point on the design surface.

20. The system of claim 17, wherein each building block includes a context menu that includes options to move the building block up in the current scope, down in the current scope, and delete the building block
